(19) United States
(12) Patent Application Publication
(10) Pub. No.: US 2009/0171793 A1
(43) Pub. Date: Jul. 2, 2009

(54) SYSTEMS AND METHODS FOR PROVIDING SAVINGS BASED UPON COMBINATION PURCHASES AT A RETAIL LEVEL

(76) Inventor: Gerry Gersovitz, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/403,031

(22) Filed: Mar. 12, 2009

Related U.S. Application Data
(63) Continuation of application No. 11/216,538, filed on Aug. 30, 2005.
(60) Provisional application No. 60/606,191, filed on Aug. 31, 2004.

(51) Int. Cl. G06Q 30/00

(52) U.S. Cl. 705/14

(57) ABSTRACT

A method of providing rewards to a customer based upon purchasing multiple items. The method comprises offering a group of multiple products for sale, providing a reward to the customer for each product of the group that is purchased, and providing a bonus reward to the customer when each product of the group is purchased.

### CROSS-REFERENCES TO RELATED APPLICATIONS

This application is a continuation of U.S. patent application Ser. No. 11/216,538, filed Aug. 30, 2005, entitled “SYSTEMS AND METHODS FOR PROVIDING SAVINGS BASED UPON COMBINATION PURCHASES AT A RETAIL LEVEL,” which claims the benefit of U.S. Patent Application No. 60/606,191, filed Aug. 31, 2004, entitled “Systems and Methods Providing Instant Combination Savings at a Retail Level.” The disclosure of each of the above references is incorporated herein by reference for all purposes.

### BACKGROUND OF THE INVENTION

1. Field of the Invention

The present invention relates to systems and methods for providing savings to consumers, and more particularly, to systems and methods for providing instant savings to consumers where the savings are provided based upon combining purchases.

2. Description of the Prior Art

Competition at the retail level is very intense, especially in the grocery industry and the pharmaceutical industry. This is specially true given the increased popularity of what are often referred to as “big box” stores. Therefore, in order to entice customers, sales are often promoted and coupons may also be issued. However, this cuts into the bottom line for these stores since they generally have to pay for these programs themselves.

### SUMMARY OF THE INVENTION

The present invention provides a system where consumers are rewarded for purchasing a group of products. Generally, the reward is in the form of receiving bonus products for free or at a special rate, thus providing “reward” savings. Generally, the products that need to be purchased in order to earn the reward savings are a national brand. The national brand company generally pays for the bonus savings.

Broadly, the present invention provides a method of providing rewards to a customer based upon purchasing multiple items. The method comprises providing a first reward to the customer for purchasing at least one first item, providing a second reward to the customer for purchasing at least one second item, and providing a bonus reward to the customer for purchasing both the first and second items.

In accordance with one aspect of the present invention, the first, second and bonus rewards are reduced prices for other products.

In accordance with another aspect of the present invention, the bonus reward is a deferred reduced overall price.

In accordance with a further aspect of the present invention, the bonus reward is an instant reduced overall price.

In accordance with another aspect of the present invention, at least one of the rewards comprises free merchandise.

In accordance with a further aspect of the present invention, the first and second items must be purchased together in order for the customer to receive the bonus reward.

In accordance with another aspect of the present invention, the first and second items may be purchased at different times in order for the customer to receive the bonus reward.

More particularly, the present invention provides a method of providing rewards to a customer based upon purchasing multiple items where the method comprises offering a group of multiple products for sale, providing a reward to the customer for each product of the group that is purchased, and providing a bonus reward to the customer when each product of the group is purchased.

In accordance with another aspect of the present invention, each product of the group of multiple products must be purchased together in order for the customer to receive the bonus reward.

In accordance with a further aspect of the present invention, each product of the group of multiple products may be purchased at different times in order for the customer to receive the bonus reward.

In accordance with another aspect of the present invention, the multiple products for sale are organized under a theme.

In accordance with another aspect of the present invention, the bonus reward is tiered.

In accordance with a further aspect of the present invention, the bonus reward is tiered based upon preferred customer levels.

Other features and advantages of the present invention will be apparent in view of the following detailed description of preferred exemplary embodiments.

### BRIEF DESCRIPTION OF THE DRAWINGS

FIG. 1 is an example of an advertisement for a savings program based upon multiple purchases in accordance with the present invention;

FIG. 2 is an example of another advertisement for a savings program based upon multiple purchases in accordance with the present invention;

FIG. 3 is an example of another advertisement for a savings program based upon multiple purchases in accordance with the present invention; and,

FIG. 4 is an example of a display for a savings program based upon multiple purchases in accordance with the present invention;

### DETAILED DESCRIPTION OF THE INVENTION

The present invention provides a program for retailers wherein reward savings are offered based upon purchasing multiple products, preferably national brand products. Preferably, the national brand companies pay for the reward savings by reimbursing or directly paying the costs to the retailers.

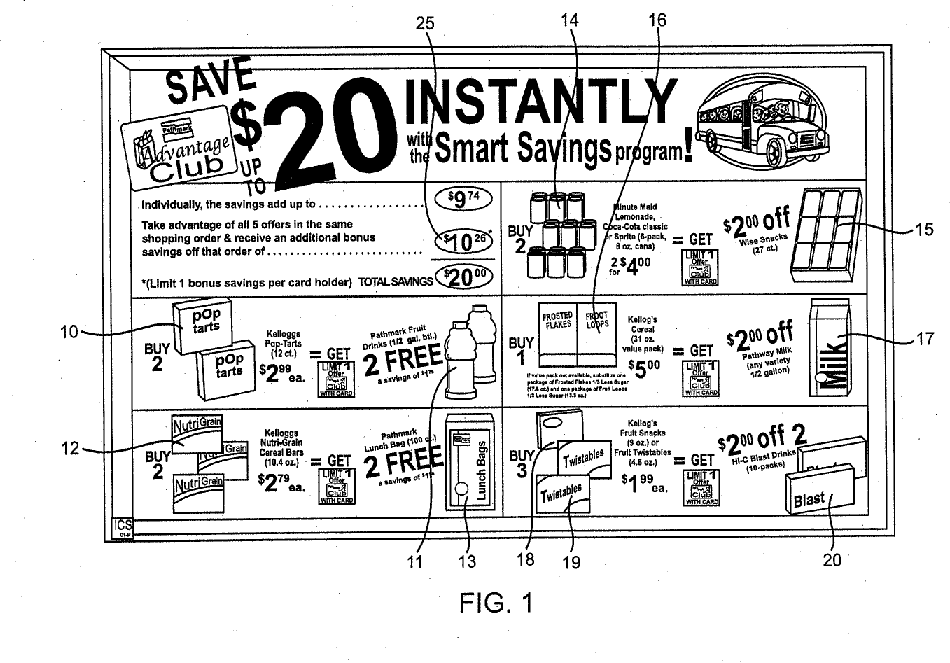

For example, it may be seen that with the program illustrated in FIG. 1, if a consumer buys two cartons of Kellogg's Pop Tarts 10, they are entitled to receive two free bottles of Pathmark fruit drinks 11. If a consumer buys two Nutra-grain cereal bar packages 12, they are entitled to two free packages of Pathmark lunch bags 13. If a consumer buys two six packs of drinks 14, they are entitled to two dollars off a package of Wise Snacks 15. If a consumer buys a Kellogg cereal value pack 16, they are entitled to two dollars off Pathmark milk 17. Finally, if a consumer purchases three packs of Kellogg's fruit snacks 18 or fruit twistables 19, they are entitled to two dollars off two Hi-C Blast drink packs 20. Thus it can be seen that rewards may be in the form of free merchandise or in the form of reduced prices.

Furthermore, one can see that with this program, savings are realized by a consumer if they buy a combination of products.

In accordance with a preferred embodiment of the present invention, if one were to take advantage of all of the offers outlined above and in FIG. 1, then one would be entitled to a bonus reward. In the example illustrated in FIG. 1, if a consumer were to take advantage of all of the individual savings, they would save $9.74 and they would be entitled to a bonus reward, which in this example is an additional $10.26 savings, or bonus savings, to provide a total savings of $20.00.

The bonus savings may be provided by providing $10.26 off of the total current order, $10.26 directly to the consumer, or by providing a credit of $10.26 towards a future purchase or order. This is at the discretion of the retailer, who may make various rules or may leave it up to the consumer.

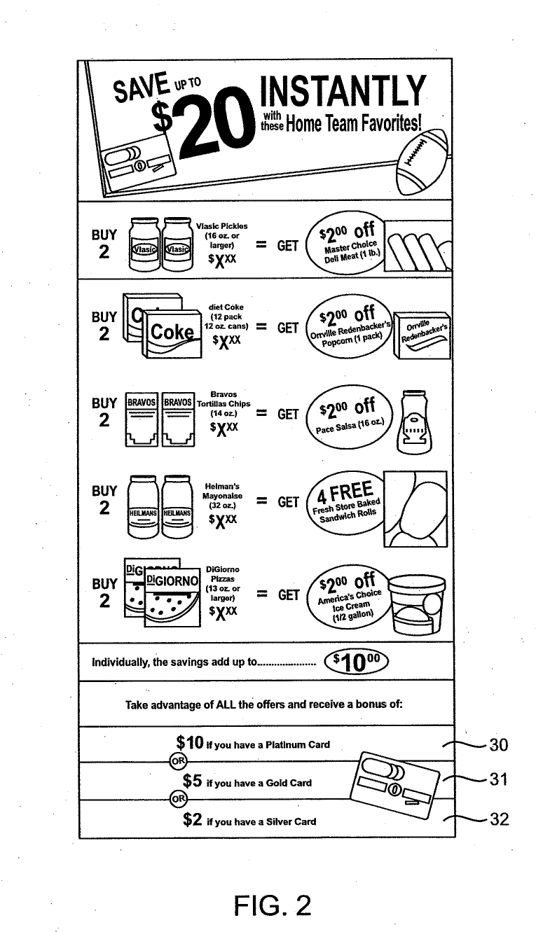

Also, preferably in order to qualify for the bonus savings, all individual offers must be purchased at once. Additionally, if a retailer has a savings card-type program, then the retailer may use this program to control how to get the bonus, i.e., next visit, next visit to a certain department, the current visit, etc. Additionally, such a program would allow for the bonuses to be tiered. For example, as may be seen in FIG. 2, a retailer's customers who have a platinum savings card would receive a ten dollar bonus 30, those having gold savings card would receive a five dollar bonus 31, and those having a silver savings card would receive a two dollar bonus 32. If desired, customers without savings cards, for example new customers, may receive the silver card bonus savings or an even lower bonus.

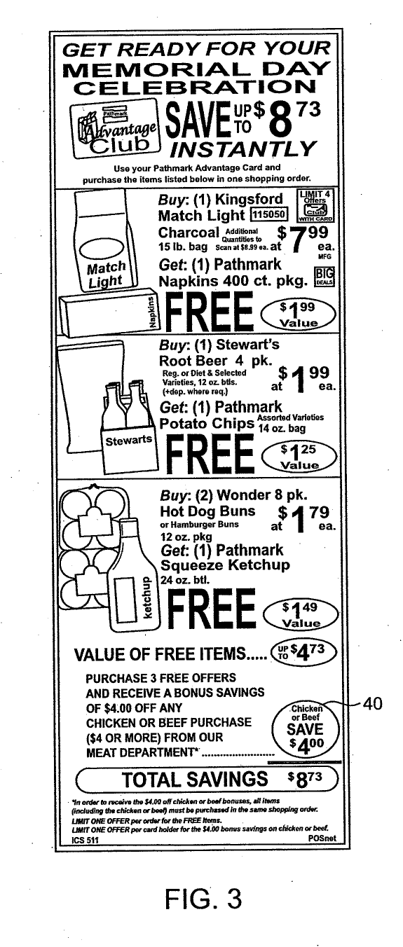

FIG. 3 illustrates bonus reward 40 being provided in the form of a reduced price for an order of meat. The reduced price may be for use on the current order or purchase, or for use with a future order or purchase. This is at the discretion of the retailer, who may make various rules or may leave it up to the consumer.

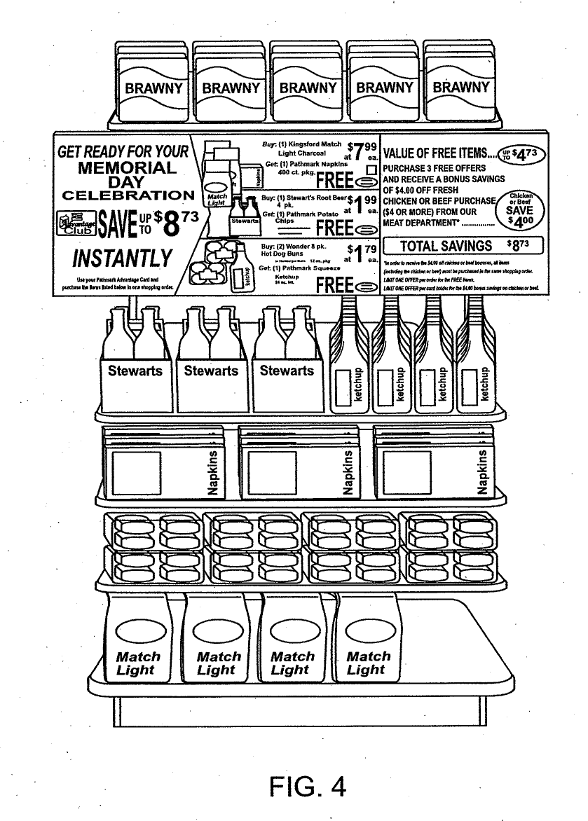

Preferably, the individual savings offered are grouped under a common theme such as a football or tailgate party, a back-to-school savings, a Super Bowl party, a holiday party, holidays in general, healthy eating, beauty, etc. FIGS. 3 and 4 illustrate a Memorial Day theme example.

Thus, the present invention provides groups of offers that are preferably sponsored by manufacturers of national brands that appear in retailer ads. Generally, these groups of offers will last one week. These ads may appear in various forms such as, for example, newspaper, mail, internet or websites, in-store ads, etc. Such programs are used to draw in good customers or new customers. If the savings are coupled with in-store brands or retailer brands, then the program can also be used to help promote the store's own brands or perimeter departments by offering savings in various departments, such as, for example, the produce department, meat department, floral department, deli, bakery, etc.

Such a program helps retailers compete against “big box” stores, provides the retailers access to national marketing funds of manufacturers or national brands, and may be used to help promote their own brands.

Preferably, a savings program based upon multiple purchases in accordance with the present invention would be run every two weeks and themes would change. Preferably, each individual offer provides approximately a twenty percent savings per offer.

Another feature that may be provided with the present invention is that for each individual offer purchased, a consumer may be entered in a drawing or contest.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of providing rewards to a customer based upon purchasing multiple items, the method comprising:
providing a first reward to the customer for purchasing at least one first item;
providing a second reward to the customer for purchasing at least one second item; and
providing a bonus reward to the customer for purchasing both the first and second items, wherein the bonus reward is a separate award from the first reward and the second reward, wherein a sponsor of the bonus reward is different from a sponsor of the first reward.

2. A method in accordance with claim 1 wherein the first, second and bonus rewards are reduced prices for other products.

3. A method in accordance with claim 2 wherein the bonus reward is a deferred reduced overall price.

4. A method in accordance with claim 2 wherein the bonus reward is an instant reduced overall price.

5. A method in accordance with claim 1 wherein at least one of the rewards comprises free merchandise.

6. A method in accordance with claim 1 wherein the first and second items must be purchased together in order for the customer to receive the bonus reward.

7. A method in accordance with claim 1 wherein the first and second items may be purchased at different times in order for the customer to receive the bonus reward.

8. A method of providing rewards to a customer based upon purchasing multiple items, the method comprising:
offering a group of multiple products for sale;
providing a reward to the customer for each product of the group that is purchased; and
providing a bonus reward to the customer when every product of the group is purchased, wherein the bonus reward is a separate award from the first reward and the second reward, wherein a sponsor of the bonus reward is different from a sponsor of the first reward.

9. A method in accordance with claim 8 wherein each reward and the bonus reward are reduced prices for other products.

10. A method in accordance with claim 9 wherein the bonus reward is a deferred reduced overall price.

11. A method in accordance with claim 9 wherein the bonus reward is an instant reduced overall price.

12. A method in accordance with claim 8 wherein at least one of the rewards comprises free merchandise.

13. A method in accordance with claim 8 wherein each product of the group of multiple products must be purchased together in order for the customer to receive the bonus reward.

14. A method in accordance with claim 8 wherein each product of the group of multiple products may be purchased at different times in order for the customer to receive the bonus reward.

15. A method in accordance with claim 8 wherein the multiple products for sale are organized under a theme.

16. A method in accordance with claim 8 wherein the bonus reward is tiered.

17. A method in accordance with claim 16 wherein the bonus reward is tiered based upon preferred customer levels.

18. A method of providing rewards to a customer, comprising:
providing a first reward to the customer for purchasing one or more national brand items, wherein the first reward is a first reduced price on the one or more national brand items; and
providing a second reward to the customer for purchasing the one or more national brand items, wherein the second reward is a second reduced price on one or more in-house items.

19. A method in accordance with claim 18 further comprising:
providing a third reward to the customer for purchasing an additional one or more national brand items, wherein the third reward is a third reduced price on the additional one or more national brand items;
providing a fourth reward to the customer for purchasing the additional one or more national brand items, wherein the fourth reward is a fourth reduced price on an additional one or more in-house items; and
providing a bonus reward to the customer for purchasing both the one or more national brand items and the additional one or more national brand items, wherein the bonus reward is a separate award from the first reward, the second reward, the third reward, and the fourth reward, wherein a sponsor of the bonus reward is different from a sponsor of the first reward and a sponsor of the third reward.
